(19) United States
(12) Patent Application Publication
(10) Pub. No.: US 2022/0285725 A1
(43) Pub. Date: Sep. 8, 2022

(54) SOLID ELECTROLYTE SHEET AND METHOD FOR PRODUCING SAME

(71) Applicant: NIPPON ELECTRIC GLASS CO., LTD., Otsu-shi, Shiga (JP)

(72) Inventors: Junichi IKEJIRI, Otsu-shi (JP); Hideo YAMAUCHI, Otsu-shi (JP); Yoshinori YAMAZAKI, Otsu-shi (JP); Ayumu TANAKA, Otsu-shi (JP)

(21) Appl. No.: 17/636,626

(22) PCT Filed: Sep. 1, 2020
(86) PCT No.: PCT/JP2020/033038

§ 371 Date: Feb. 18, 2022

(30) Foreign Application Priority Data
Sep. 5, 2019 (JP) 2019-162045
Dec. 23, 2019 (JP) 2019-231602
Apr. 8, 2020 (JP) 2020-069519

(51) Int. Cl. H01M 10/0562; H01M 10/0585; C01F 7/021; C01B 25/45

(52) U.S. Cl. CPC H01M 10/0562; H01M 10/0585; C01F 7/021; C01B 25/45; H01M 2300/002; C01P 2006/40; C01P 2006/12; C01P 2004/62; C01P 2004/61

(57) ABSTRACT

Provided is a solid electrolyte sheet capable of increasing the adhesiveness to the electrode layer and thus achieving an excellent discharge capacity. A solid electrolyte sheet 10 in which a second solid electrolyte layer 2 is formed on at least one of both surfaces of a first solid electrolyte layer 1, the second solid electrolyte layer 2 being a porous solid electrolyte layer.

### TECHNICAL FIELD

The present invention relates to solid electrolyte sheets which are members constituting all-solid-state batteries for use in mobile electronic devices, electric vehicles, and so on.

### BACKGROUND ART

Lithium ion secondary batteries have secured their place as high-capacity and light-weight power sources essential for mobile devices, electric vehicles, and so on. Current lithium ion secondary batteries employ as their electrolytes, mainly, combustible organic electrolytic solutions and, therefore, raise concerns about the risk of ignition or the like. As a solution to this problem, developments of lithium ion all-solid-state batteries using a solid electrolyte instead of an organic electrolytic solution have been promoted (see, for example, Patent Literature 1).

Furthermore, because an issue of concern with lithium is global price increase of raw materials therefor, sodium also has attracted attention as a material to replace lithium and there is proposed a sodium ion all-solid-state battery in which NASICON-type sodium ion-conductive crystals made of Na₃Zr₂Si₂PO₁₂ are used as a solid electrolyte (see, for example, Patent Literature 2). Alternatively, beta-alumina-based solid electrolytes, including β-alumina (theoretical composition formula: Na₂O.11Al₂O₃), β″-alumina (theoretical composition formula: Na₂O.5.3Al₂O₃), Li₂O-stabilized β″-alumina (Na_{1.7}Li_{0.3}Al_{10.7}O₁₇), and MgO-stabilized β″-alumina ((Al_{10.32}MgO_{0.68}O₁₆) (Na_{1.68}O)), and Na₅YSi₄O₁₂ are also known to exhibit high sodium-ion conductivity. These solid electrolytes can also be used for sodium ion all-solid-state batteries.

In all-solid-state batteries, it is important to reduce the interfacial resistance between an electrode layer and a solid electrolyte layer in order to increase the discharge capacity. To cope with this, in order to increase the adhesiveness between both the layers, a technique is proposed for increasing the surface roughness of the solid electrolyte layer (see, for example, Patent Literature 3).

### CITATION LIST

### Patent Literature

[PTL 1]JP-A-H05-205741
[PTL 2]JP-A-2010-15782
[PTL 3]WO2015/128982

### SUMMARY OF INVENTION

### Technical Problem

However, it is difficult to sufficiently increase the discharge capacity simply by increasing the surface roughness of the solid electrolyte layer. Particularly, if the thickness of the electrode layer is increased, the electrode layer may peel off from the solid electrolyte layer in a firing process during production of the all-solid-state battery, which makes charge and discharge themselves impossible.

In view of the foregoing, the present invention has an object of providing a solid electrolyte sheet capable of increasing the adhesiveness to the electrode layer and thus achieving an excellent discharge capacity.

### Solution to Problem

The inventors conducted intensive studies and, as a result, found that the above challenge can be solved by a solid electrolyte sheet having a particular structure.

Specifically, a solid electrolyte sheet according to the present invention is a solid electrolyte sheet in which a second solid electrolyte layer is formed on at least one of both surfaces of a first solid electrolyte layer, wherein the second solid electrolyte layer is a porous solid electrolyte layer.

In the solid electrolyte sheet according to the present invention, the second solid electrolyte layer is preferably a porous solid electrolyte layer having three-dimensionally connected voids. Thus, when an electrode layer is formed on the second solid electrolyte layer, the material forming the electrode layer can easily penetrate the voids in the second solid electrolyte layer, so that the electrode layer and the solid electrolyte sheet can firmly adhere to each other. Therefore, the area of contact between the electrode layer and the solid electrolyte sheet increases, so that the interfacial resistance between the electrode layer and the solid electrolyte layer can be reduced. In addition, in the firing process during production of the all-solid-state battery, an anchoring effect leads to the electrode layer being less likely to peel off from the solid electrolyte layer. As a result, an all-solid-state battery having an excellent discharge capacity can be obtained.

In the solid electrolyte sheet according to the present invention, assuming that in a cross-sectional image of an interface between the first solid electrolyte layer and the second solid electrolyte layer and around the interface, a straight line drawn along a surface of the first solid electrolyte layer is a reference line and a curved line drawn along a surface of the second solid electrolyte layer is a profile line, a ratio of a length of the profile line to a length of the reference line ((profile line length)/(reference line length)) is preferably 1.3 to 50. The ratio of the length of the profile line to the length of the reference line defined as above is a parameter providing an indication of how three-dimensionally connected voids are formed in the second solid electrolyte layer. When the above ratio is within the above range, three-dimensionally connected voids are formed well in the second solid electrolyte layer, which enables firm adhesion between the electrode layer and the solid electrolyte sheet.

In the solid electrolyte sheet according to the present invention, the second solid electrolyte layer is preferably composed of a plurality of layers having different porosity rates. Particularly, in the plurality of layers having different porosity rates, the layer closer to the first solid electrolyte layer preferably has a lower porosity rate. Thus, the second solid electrolyte layer can be prevented from peeling off at the interface with the first solid electrolyte layer.

In the solid electrolyte sheet according to the present invention, a surface area of the second solid electrolyte layer per cm² in plan view is preferably 3 cm² or more. The surface area of the second solid electrolyte layer defined as just described is also a parameter providing an indication of how three-dimensionally connected voids are formed in the second solid electrolyte layer. When the above surface area is within the above range, three-dimensionally connected voids are formed well in the second solid electrolyte layer, so that the area of contact between the electrode layer and the solid electrolyte sheet increases and the adhesiveness between them increases, which enables firm bonding between them. Therefore, the interfacial resistance between the electrode layer and the solid electrolyte sheet can be reduced and, as a result, a battery having an excellent discharge capacity can be obtained.

In the solid electrolyte sheet according to the present invention, the second solid electrolyte layer preferably has an arithmetic mean roughness Ra of 2.5 μm or more. Thus, the adhesiveness between the electrode layer and the solid electrolyte sheet can be further increased.

In the solid electrolyte sheet according to the present invention, the second solid electrolyte layer is preferably formed on each of both surfaces of the first solid electrolyte layer. Thus, both a positive electrode layer and a negative electrode layer can firmly adhere to the solid electrolyte sheet.

The solid electrolyte sheet according to the present invention preferably has a thickness of 2400 μm or less. A smaller thickness of the solid electrolyte sheet is preferred because the distance required for ionic conduction in the solid electrolyte becomes shorter and, thus, the ionic conductivity becomes greater. In addition, when the solid electrolyte sheet is used as a solid electrolyte for an all-solid-state battery, the energy density per unit volume of the all-solid-state battery becomes higher.

In the solid electrolyte sheet according to the present invention, the first solid electrolyte layer and/or the second solid electrolyte layer preferably contain at least one material selected from β″-alumina, β-alumina, and NASICON crystals.

The solid electrolyte sheet according to the present invention can be used, for example, for an all-solid-state sodium ion secondary battery.

An all-solid-state secondary battery according to the present invention includes the above-described solid electrolyte sheet and an electrode layer formed on a surface of the second solid electrolyte layer of the solid electrolyte sheet.

In the all-solid-state secondary battery according to the present invention, the voids in the second solid electrolyte layer are preferably penetrated by a material forming the electrode layer. Thus, the adhesiveness between the electrode layer and the second solid electrolyte layer can be increased.

A method for producing a solid electrolyte sheet according to the present invention is a method for producing the above-described solid electrolyte sheet and includes the steps of: (a) adding an organic vehicle containing a binder to a solid electrolyte powder and/or a raw material powder for the solid electrolyte powder to make a slurry, applying the slurry to a base material, and then drying the slurry to obtain a green sheet for a first solid electrolyte layer; (b) adding an organic vehicle containing a binder to a mixed powder containing a solid electrolyte powder and/or a raw material powder for the solid electrolyte powder and a polymer powder to make a slurry, applying the slurry to abase material, and then drying the slurry to obtain a green sheet for a second solid electrolyte layer; (c) laying the green sheet for a second solid electrolyte layer on at least one of both surfaces of the green sheet for a first solid electrolyte layer to obtain a laminate; and (d) firing the laminate to remove the binder in the green sheet for a first solid electrolyte layer and thus form a first solid electrolyte layer and concurrently remove the binder and polymer particles in the green sheet for a second solid electrolyte layer and thus form a second solid electrolyte layer. By doing so, it is possible to easily produce a solid electrolyte sheet in which a porous second solid electrolyte layer having three-dimensionally connected voids is formed at least one surface of the first solid electrolyte layer.

A method for producing a solid electrolyte sheet according to the present invention is a method for producing the above-described solid electrolyte sheet and includes the steps of: (a) preparing a first solid electrolyte layer; (b) adding an organic vehicle containing a binder to a mixed powder containing a solid electrolyte powder and/or a raw material powder for the solid electrolyte powder and a polymer powder to make a slurry; (c) applying the slurry to at least one of both surfaces of the first solid electrolyte layer to obtain a laminate in which a slurry layer is formed on the surface of the first solid electrolyte layer; and (d) firing the laminate to remove the binder and polymer particles in the slurry layer and thus form a second solid electrolyte layer. Also by this production method, it is possible to easily produce a solid electrolyte sheet in which a porous second solid electrolyte layer having three-dimensionally connected voids is formed at least one surface of the first solid electrolyte layer.

In the method for producing the solid electrolyte sheet according to the present invention, the polymer powder preferably has an average particle diameter of 0.1 to 100 μm.

In the method for producing the solid electrolyte sheet according to the present invention, a content ratio of the solid electrolyte powder and/or the raw material powder for the solid electrolyte powder to the polymer powder is preferably 75:25 to 3:97 in terms of volume ratio.

### Advantageous Effects of Invention

The present invention enables provision of a solid electrolyte sheet capable of increasing the adhesiveness to the electrode layer and thus achieving an excellent discharge capacity.

### BRIEF DESCRIPTION OF DRAWINGS

FIG. 1 is a schematic cross-sectional view showing an embodiment of a solid electrolyte sheet according to the present invention.

FIG. 2 is a cross-sectional image of the interface between a first solid electrolyte layer and a second solid electrolyte layer and around the interface in a solid electrolyte sheet of Example 1, wherein 2(a) is a view showing a reference line which is a straight line drawn along a surface of the first solid electrolyte layer, and 2(b) is a view showing a profile line which is a curved line drawn along a surface of the second solid electrolyte layer.

### DESCRIPTION OF EMBODIMENTS

Hereinafter, a detailed description will be given of an embodiment of a solid electrolyte sheet according to the present invention with reference to the drawings.

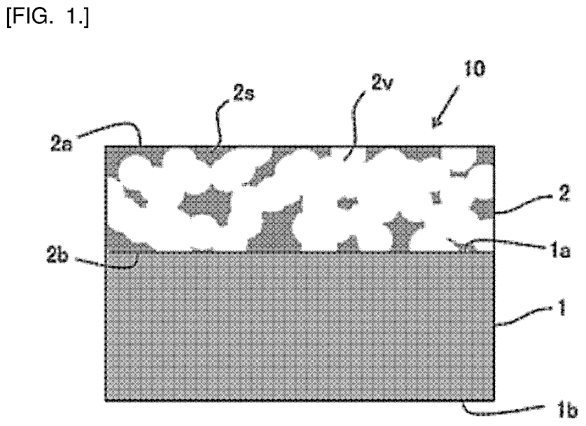

FIG. 1 is a schematic cross-sectional view showing an embodiment of a solid electrolyte sheet according to the present invention. A solid electrolyte sheet 10 according to the present invention includes a first solid electrolyte layer 1 and a second solid electrolyte layer 2 formed on one of both surfaces of the first solid electrolyte layer 1. The second solid electrolyte layer is a porous solid electrolyte layer having a solid electrolyte 2s and three-dimensionally connected voids 2v.

In producing an all-solid-state battery with the use of the solid electrolyte sheet 10, an electrode layer (a positive electrode layer or a negative electrode layer) is formed on each of both surfaces of the solid electrolyte sheet 10. Specifically, two electrode layers are formed one on a principal surface 1b of the first solid electrolyte layer 1 opposite to the second solid electrolyte layer 2 and the other on a principal surface 2a of the second solid electrolyte layer 2 opposite to the first solid electrolyte layer 1. At this time, since the second solid electrolyte layer has three-dimensionally connected voids 2v, the material (an active material powder and so on) forming an electrode layer can easily penetrate into the voids 2v, so that the electrode layer and the second solid electrolyte layer 2 can firmly adhere to each other. Therefore, the area of contact between the electrode layer and the solid electrolyte sheet 10 (the second solid electrolyte layer 2) increases and the ion-conducting path thus increases, so that the interfacial resistance between the electrode layer and the solid electrolyte sheet 10 can be reduced. In addition, in the firing process during production of the all-solid-state battery, an anchoring effect leads to the electrode layer being less likely to peel off from the solid electrolyte layer 10. As a result, an all-solid-state battery having an excellent discharge capacity can be obtained.

Furthermore, when the electrode layer is made of a low-melting-point material, such as metallic sodium, the material may be softened and fluidified during production of an all-solid-state battery or during charge and discharge to flow via lateral sides of the solid electrolyte sheet 10 to the counter electrode layer, resulting in the occurrence of a short-circuit. However, in the solid electrolyte sheet 10 of this embodiment, a softened and fluidified low-melting-point material penetrates the voids 2v in the second solid electrolyte layer 2, which offers the advantage that the above-described flow to the counter electrode layer and the resultant short-circuit are less likely to occur. In addition, because the relatively dense first solid electrolyte layer 1 serves as a barrier, the problem of occurrence of a short-circuit due to reaching of the low-melting-point material through the inside of the solid electrolyte sheet 10 to the counter electrode layer is less likely to arise.

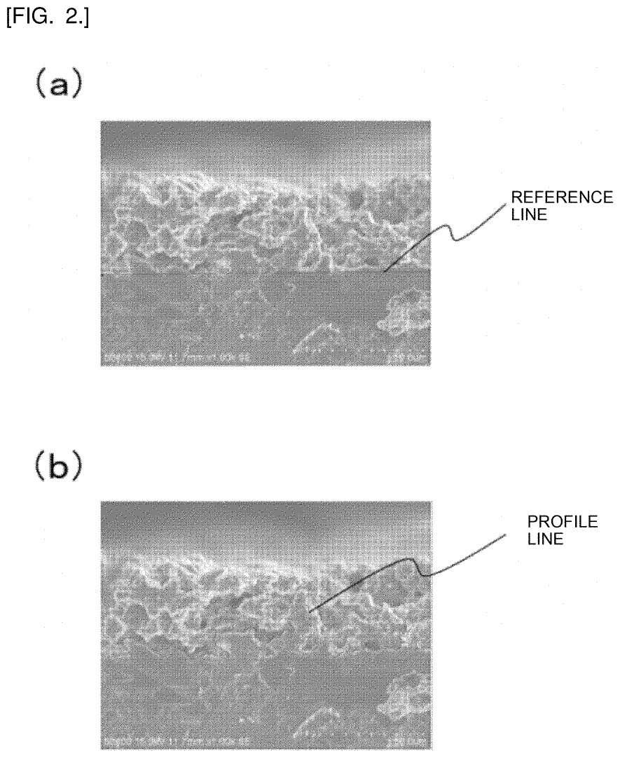

Assuming that, in a cross-sectional image of the interface between the first solid electrolyte layer 1 and the second solid electrolyte layer 2 and around the interface, a straight line drawn along the surface of the first solid electrolyte layer 1 is a reference line and a curved line drawn along the surface of the second solid electrolyte layer 2 is a profile line, the ratio of the length of the profile line to the length of the reference line ((profile line length)/(reference line length)) is preferably 1.3 to 50, more preferably 1.5 to 20, still more preferably 1.8 to 10, and particularly preferably 2 to 5 (see Examples described below and FIG. 2). The ratio of the length of the profile line to the length of the reference line defined as above is a parameter providing an indication of how three-dimensionally connected voids 2v are formed in the second solid electrolyte layer 2. If this ratio is too small, there is a tendency that the three-dimensionally connected voids 2v are not sufficiently formed in the second solid electrolyte layer 2 and, thus, the adhesiveness between the electrode layer and the solid electrolyte sheet 10 becomes poor. On the other hand, if this ratio is too large, the mechanical strength of the second solid electrolyte layer 2 tends to be poor.

The surface area of the second solid electrolyte layer per cm² in plan view is preferably 3 cm² or more, more preferably 5 cm² or more, still more preferably 7 cm² or more, and particularly preferably 10 cm² or more. If the above surface area is too small, there is a tendency that the three-dimensionally connected voids 2v are not sufficiently formed in the second solid electrolyte layer 2, the area of contact between the electrode layer and the solid electrolyte sheet 10 is small, and, thus, the adhesiveness between them becomes poor. On the other hand, if the above surface area is too large, the mechanical strength of the second solid electrolyte layer 2 tends to be poor. Therefore, the surface area is preferably not more than 30 cm². The above surface area can be determined by a method described in Examples below.

Although in this embodiment the second solid electrolyte layer 2 is formed only on one surface of the first solid electrolyte layer 1, the second solid electrolyte layer 2 may be formed on each of both surfaces of the first solid electrolyte layer 1. By doing so, both surfaces of the solid electrolyte sheet 10 are each formed of the second solid electrolyte layer 2, so that both the positive electrode layer and the negative electrode layer can firmly adhere to the solid electrolyte sheet.

A smaller thickness of the solid electrolyte sheet 10 is preferred because the distance required for ionic conduction in the solid electrolyte becomes shorter and, thus, the ionic conductivity becomes greater. In addition, when the solid electrolyte sheet 10 is used as a solid electrolyte sheet for an all-solid-state battery, the all-solid-state battery has a higher energy density per unit volume. Specifically, the thickness of the solid electrolyte sheet 10 is preferably 2400 μm or less, 2000 μm or less, 1500 μm or less, 1000 μm or less, 500 μm or less, 400 μm or less, or 300 μm or less, and particularly preferably 200 μm or less. However, if the thickness of the solid electrolyte sheet 10 is too small, a problem may occur such as decrease of the mechanical strength or a short-circuit between the positive electrode and the negative electrode. Therefore, the thickness of the solid electrolyte sheet 10 is preferably not less than 5 μm, not less than 10 μm, or not less than 20 μm, and particularly preferably not less than 30 μm.

Hereinafter, a detailed description will be given of constitutional elements.

(First Solid Electrolyte Layer 1)

The first solid electrolyte layer 1 serves mainly as a substrate layer for ensuring the mechanical strength of the solid electrolyte sheet 10. Therefore, the first solid electrolyte layer 1 preferably has a denser structure than the second solid electrolyte layer 2. In other words, the first solid electrolyte layer 1 preferably has a smaller voidage than the second solid electrolyte layer 2. Specifically, in the first solid electrolyte layer 1, the voidage defined by the following formula is preferably 20% or less, more preferably 10% or less, and particularly preferably 5% or less.

Voidage=(1−p/p0)×100(%)

p: bulk density, p0: true density

In the case of use of the solid electrolyte sheet 10 for an all-solid-state sodium ion secondary battery, the first solid electrolyte layer 1 preferably contains at least one material selected from β″-alumina, β-alumina, and NASICON crystals. Specific examples of β″-alumina include the following trigonal crystals: (Al_{10.35}Mg_{0.65}O₁₆) (Na_{1.65}O), (Al_{8.87}Mg_{2.13}O₁₆) (Na_{3.13}O), Na_{1.67}Mg_{0.67}Al_{10.33}O₁₇, Na_{1.49}Li_{0.25}Al_{10.75}O₁₇, Na_{1.72}Li_{0.3}Al_{10.66}O₁₇, and Na_{1.6}Li_{0.34}Al_{10.66}O₁₇. The first solid electrolyte layer 1 may contain, in addition to β″-alumina, β-alumina. Examples of β-alumina include the following hexagonal crystals: (Al_{10.35}Mg_{0.65}O₁₆) (Na_{1.65}O), (Al_{10.37}Mg_{0.63}O₁₆) (Na_{1.63}O), NaAl₁₁O₁₇, and (Al_{10.32}Mg_{0.68}O₁₆) (Na_{1.68}O).

An example of a specific composition of the β″-alumina is a composition containing, in terms of % by mole, 65 to 98% Al₂O₃, 2 to 20% Na₂O, 0.3 to 15% MgO+Li₂O, 0 to 20% ZrO₂, and 0 to 5% Y₂O₃. Reasons why the composition is limited as just described will be described below.

Al₂O₃ is a main component that forms β″-alumina. The content of Al₂O₃ is preferably 65 to 98% and particularly preferably 70 to 95%. If Al₂O₃ is too less, the ionic conductivity of the solid electrolyte is likely to decrease. On the other hand, if Al₂O₃ is too much, α-alumina having no sodium-ion conductivity remains in the solid electrolyte, so that the ionic conductivity of the solid electrolyte is likely to decrease.

Na₂O is a component that gives the solid electrolyte a sodium-ion conductivity. The content of Na₂O is preferably 2 to 20%, more preferably 3 to 18%, and particularly preferably 4 to 16%. If Na₂O is too less, the above effect is less likely to be achieved. On the other hand, if Na₂O is too much, surplus sodium forms compounds not contributing to ionic conductivity, such as NaAlO₂, so that the ionic conductivity is likely to decrease.

MgO and Li₂O are components (stabilizing agents) that stabilize the structure of β″-alumina. The content of MgO+Li₂O is preferably 0.3 to 15%, more preferably 0.5 to 10%, and particularly preferably 0.8 to 8%. If MgO+Li₂O is too less, α-alumina remains in the solid electrolyte, so that the ionic conductivity is likely to decrease. On the other hand, if MgO+Li₂O is too much, MgO or Li₂O having failed to function as a stabilizing agent remains in the solid electrolyte, so that the ionic conductivity is likely to decrease.

ZrO₂ and Y₂O₃ have the effect of inhibiting abnormal grain growth of β″-alumina during firing to increase the adhesiveness of particles of β″-alumina. As a result, the ionic conductivity of the solid electrolyte sheet is likely to increase. The content of ZrO₂ is preferably 0 to 15%, more preferably 1 to 13%, and particularly preferably 2 to 10%. The content of Y₂O₃ is preferably 0 to 5%, more preferably 0.01 to 4%, and particularly preferably 0.02 to 3%. If ZrO₂ or Y₂O₃ is too much, the amount of β″-alumina produced decreases, so that the ionic conductivity of the solid electrolyte is likely to decrease.

The NASICON crystals are preferably made of a compound represented by a general formula NaₛA1ₜA2ᵤOᵥ (where A1 is at least one selected from Al, Y, Yb, Nd, Nb, Ti, Hf, and Zr, A2 is at least one selected from Si and P, s=1.4 to 5.2, t=1 to 2.9, u=2.8 to 4.1, and v=9 to 14). In this relation, A1 is preferably at least one selected from Y, Nb, Ti, and Zr. By doing so, crystals having excellent ionic conductivity can be obtained.

The respective preferred ranges of the indices in the above general formula are as follows.

The index s is preferably 1.4 to 5.2, more preferably 2.5 to 3.5, and particularly preferably 2.8 to 3.1. If s is too small, the amount of sodium ions is small, so that the ionic conductivity is likely to decrease. On the other hand, if s is too large, surplus sodium forms compounds not contributing to ionic conductivity, such as sodium phosphate and sodium silicate, so that the ionic conductivity is likely to decrease.

The index t is preferably 1 to 2.9, more preferably 1 to 2.5, and particularly preferably 1.3 to 2. If t is too small, the three-dimensional network in crystals reduces, so that the ionic conductivity is likely to decrease. On the other hand, if t is too large, compounds not contributing to ionic conductivity, such as zirconia and alumina, are formed, so that the ionic conductivity is likely to decrease.

The index u is preferably 2.8 to 4.1, more preferably 2.8 to 4, still more preferably 2.9 to 3.2, and particularly preferably 2.95 to 3.1. If u is too small, the three-dimensional network in crystals reduces, so that the ionic conductivity is likely to decrease. On the other hand, if u is too large, crystals not contributing to ionic conductivity are formed, so that the ionic conductivity is likely to decrease.

The index v is preferably 9 to 14, more preferably 9.5 to 12, and particularly preferably 11 to 12. If v is too small, A1 (for example, an aluminum component) has a low valence, so that the electric insulation property is likely to decrease. On the other hand, if v is too large, an excessively oxidated state occurs, so that sodium ions are bonded to lone pairs of electrons of oxygen atoms and, therefore, the ionic conductivity is likely to decrease.

The above-described NASICON crystals are preferably monoclinic crystals, hexagonal crystals or trigonal crystals, and particularly preferably monoclinic or trigonal because they have excellent ionic conductivity.

Specific examples of the NASICON crystal include the following crystals: Na₃Zr₂Si₂PO₁₂, Na_{3.2}Zr_{1.3}Si_{2.2}P_{0.8}O_{10.5}, Na₃Zr_{1.6}Ti_{0.4}Si₂PO₁₂, Na₃Hf₂Si₂PO₁₂, Na_{3.4}Zr_{0.9}Hf_{1.4}Al_{0.6}Si_{1.2}P_{1.8}O₁₂, Na₃Zr_{1.7}Nb_{0.24}Si₂PO₁₂, Na_{3.6}Ti_{0.2}Y_{0.8}Si_{2.8}O₉, Na₃Zr_{1.88}Y_{0.12}Si₂PO₁₂, Na_{3.12}Zr_{1.88}Y_{0.12}Si₂PO₁₂, Na_{3.05}Zr₂Si_{2.06}P_{0.95}O₁₂, Na_{3.6}Zr_{0.13}Yb_{1.67}Si_{0.11}P_{2.9}O₁₂, and Na₅YSi₄O₁₂. Particularly, Na_{3.12}Zr_{1.88}Y_{0.12}Si₂PO₁₂ and Na_{3.05}Zr₂Si_{2.06}P_{0.95}O₁₂ are preferred because they have excellent ionic conductivity.

In the case of use of the solid electrolyte sheet 10 for an all-solid-state lithium ion secondary battery, the first solid electrolyte layer 1 preferably contains at least one selected from La_{0.51}Li_{0.34}Ti_{2.94}, Li_{1.3}Al_{0.3}Ti_{1.7} (PO₄)₃, Li₇La₃Zr₂O₁₂, Li_{1.07}Al_{0.69}Ti_{1.46}(PO₄)₃, and Li_{1.5}Al_{0.5}Ge_{1.5}(PO₄)₃.

The thickness of the first solid electrolyte layer 1 is preferably 4 to 400 μm, more preferably 10 to 300 μm, still more preferably 20 to 200 μm, and particularly preferably 30 to 100 μm. If the thickness of the first solid electrolyte layer 1 is too small, a problem may occur such as decrease of the mechanical strength or a short-circuit between the positive electrode and the negative electrode. On the other hand, if the thickness of the first solid electrolyte layer 1 is too large, the ionic conductivity of the solid electrolyte sheet 10 is likely to decrease. In addition, the all-solid-state battery tends to have a high energy density per unit volume.

(Second Solid Electrolyte Layer 2) As described previously, the second solid electrolyte layer 2 is a porous solid electrolyte layer having three-dimensionally connected voids 2v. The voidage of the second solid electrolyte layer 2 is preferably 30% or more, more preferably 50% or more, still more preferably 60% or more, and particularly preferably 70% or more. If the voidage of the second solid electrolyte layer 2 is too small, three-dimensionally connected voids 2v are less likely to be formed, so that the adhesiveness between the electrode layer and the solid electrolyte sheet 10 tends to be poor. The upper limit of the voidage of the second solid electrolyte layer 2 is not particularly limited, but it is, actually, preferably not more than 99% and more preferably not more than 97%.

The degree of porousness of the second solid electrolyte layer 2 can also be evaluated, in a different perspective from the voidage, by the porosity rate defined below. The porosity rate of the second solid electrolyte layer 2 is preferably 20% or more, more preferably 25% or more, and particularly preferably 30% or more. If the porosity rate of the second solid electrolyte layer 2 is too small, three-dimensionally connected voids 2v are less likely to be formed, so that the adhesiveness between the electrode layer and the solid electrolyte sheet 10 tends to be poor. The upper limit of the porosity rate of the second solid electrolyte layer 2 is not particularly limited, but it is, actually, preferably not more than 99% and more preferably not more than 97%.

The porosity rate is defined in the following manner. A backscattered electron topographic image of a depthwise torn surface of the second solid electrolyte layer 2 is binarized to be divided into a porous portion and a non-porous portion. The rate of the area of the porous portion to the total area is defined as the porosity rate.

The arithmetic mean roughness Ra of the second solid electrolyte layer 2 (the arithmetic mean roughness of its principal surface 2a) is preferably 2.5 μm or more, more preferably 3 μm or more, still more preferably 4 μm or more, yet still more preferably 5 μm or more, and particularly preferably 5.6 μm or more. Thus, the adhesiveness between the electrode layer and the solid electrolyte sheet 10 can be further increased. The upper limit of the arithmetic mean roughness Ra of the second solid electrolyte layer 2 is not particularly limited, but it is, actually, preferably not more than 20 μm and more preferably not more than 15 μm.

In the case of use of the second solid electrolyte layer 2 for an all-solid-state sodium ion secondary battery, like the first solid electrolyte layer 1, the second solid electrolyte layer 2 preferably contains at least one material selected from β″-alumina, β-alumina, and NASICON crystals. In the case of use of the second solid electrolyte layer 2 for an all-solid-state lithium ion secondary battery, the second solid electrolyte layer 2 preferably contains at least one selected from La_{0.51}Li_{0.34}Ti_{2.94}, Li_{1.3}Al_{0.3}Ti_{1.7}(PO₄)₃, Li₇La₃Zr₂O₁₂, Li_{1.07}Al_{0.69}Ti_{1.46}(PO₄)₃, and Li_{1.5}Al_{0.5}Ge_{1.5}(PO₄)₃. From the perspective of increasing the adhesiveness between the first solid electrolyte layer 1 and the second solid electrolyte layer 2 or reducing the interfacial resistance between these layers, the first solid electrolyte layer 1 and the second solid electrolyte layer 2 are preferably made of the same material.

The thickness of the second solid electrolyte layer 2 is preferably 2 to 1000 μm, more preferably 10 to 800 μm, still more preferably 15 to 600 μm, and particularly preferably 20 to 500 μm. If the thickness of the second solid electrolyte layer 2 is too small, the amount of the electrode layer-forming material penetrating the voids in the second solid electrolyte layer 2 is small, so that the area of contact between the electrode layer and the solid electrolyte sheet 10 becomes small and, thus, the adhesiveness between them is likely to decrease. In this case, the ion-conducting path at the interface between the electrode layer and the solid electrolyte sheet 10 becomes small, so that the internal resistance of the battery tends to be high. As a result, the rapid charge/discharge characteristic is likely to decrease. On the other hand, if the thickness of the second solid electrolyte layer 2 is too large, the material for the electrode layer is difficult to fill in all the voids of the second solid electrolyte layer 2, so that the energy density per unit volume becomes low. In addition, the amount of contraction of the second solid electrolyte layer 2 during formation thereof becomes large, so that the second solid electrolyte layer 2 is likely to peel off at the interface with the first solid electrolyte layer 1.

The rate of the thickness of the second solid electrolyte layer 2 to the thickness of the solid electrolyte sheet 10 is preferably 10% or more, more preferably 15% or more, and particularly preferably 20% or more. If this rate is too small, the area of contact between the electrode layer and the solid electrolyte sheet 10 becomes small and, thus, the ionic conductivity decreases, so that the rapid charge/discharge characteristic tends to deteriorate. The upper limit of the above rate is not particularly limited, but it is, actually, preferably not more than 99% and more preferably not more than 97%.

The second solid electrolyte layer 2 may be composed of a plurality of layers having different porosity rates. In this case, the plurality of layers having different porosity rates are preferably provided so that the layer closer to the first solid electrolyte layer 1 has a lower porosity rate. In this case, the number of layers forming the second solid electrolyte layer 2 is preferably two or more, more preferably three or more, still more preferably four or more, and particularly preferably five or more. The upper limit of the number of layers is not particularly limited, but, in consideration of production efficiency, it is preferably not more than 200, not more than 150, not more than 100, not more than 50, not more than 20, or not more than 10.

As described previously, if the thickness of the second solid electrolyte layer 2 is too large, the amount of contraction of the second solid electrolyte layer 2 during formation thereof becomes large, which presents the problem that the second solid electrolyte layer 2 is likely to peel off at the interface with the first solid electrolyte layer 1. In this relation, when as described above the second solid electrolyte layer 2 includes two or more layers having different porosity rates and, particularly, the layer closer to the first solid electrolyte layer 1 has a lower porosity rate, the amount of contraction of the second solid electrolyte layer 2 in the vicinity of the interface with the first solid electrolyte layer 1 becomes small, so that the second solid electrolyte layer 2 can be prevented from peeling off at the interface with the first solid electrolyte layer 1.

In the case where the second solid electrolyte layer 2 is formed of the plurality of layers, the porosity rate of the layer closest to the first solid electrolyte layer 1 is preferably 50% or less, more preferably 45% or less, and particularly preferably 40% or less. This is preferred because the amount of contraction of the second solid electrolyte layer 2 in the vicinity of the interface with the first solid electrolyte layer 1 becomes small and, thus, peel-off thereof from the first solid electrolyte layer 1 can be prevented.

In the case where the second solid electrolyte layer 2 is formed of the plurality of layers, the difference in porosity rate between the layer closest to the first solid electrolyte layer 1 and the layer farthest thereto is preferably 5% or more, more preferably 10% or more, and particularly preferably 15% or more. Thus, it is possible to concurrently achieve the prevention of the second solid electrolyte layer 2 from peeling off from the first solid electrolyte layer 1 and the increase in adhesiveness between the electrode layer and the solid electrolyte sheet 10.

Also in the case where the second solid electrolyte layer 2 is formed of the plurality of layers, the whole porosity rate of the second solid electrolyte layer 2 is, like the above, preferably 20% or more, more preferably 25% or more, and particularly preferably 30% or more. The whole thickness of the second solid electrolyte layer 2 is also, like the above, preferably 2 to 1000 μm, more preferably 10 to 800 μm, still more preferably 15 to 600 μm, and particularly preferably 20 to 500 μm. The thickness of each layer forming the second solid electrolyte layer 2 is preferably 2 to 900 μm, more preferably 10 to 800 μm, still more preferably 15 to 600 μm, and particularly preferably 20 to 500 μm.

A metallic layer is preferably provided on one or both of the surfaces of the second solid electrolyte layer 2. Particularly, when the electrode layer to be formed on the second solid electrolyte layer 2 is made of metallic sodium, metallic lithium or like material, the provision of the metallic layer between the second solid electrolyte layer 2 and the electrode layer improves the wettability between the electrode layer and the second solid electrolyte layer 2 to increase the adhesiveness between them and enable reduction in interfacial resistance. Thus, an all-solid-state battery having an excellent discharge capacity can be obtained. In addition, for the reasons below, the cycle characteristics of the all-solid-state battery can be increased.

If the adhesiveness between the electrode layer and the second solid electrolyte layer 2 is poor, this interferes with migration of sodium ions or lithium ions involved in charge and discharge, so that sodium or lithium tends to precipitate as acicular metallic crystals (dendrites). Because the acicular metallic crystals form high-resistance portions, the in-plane resistance at the interface between the electrode layer and the second solid electrolyte layer 2 is likely to have a variation, so that the cycle characteristics tend to decrease. Unlike the above, when the metallic layer is provided between the second solid electrolyte layer 2 and the electrode layer, the adhesiveness between the electrode layer and the second solid electrolyte layer 2 increases, so that the precipitation of acicular metallic crystals can be reduced and, thus, the cycle characteristics can be increased.

Although no particular limitation is placed on the type of metal forming the metallic layer, examples that can be used include Sn, Ti, Bi, Au, Al, Cu, Sb, and Pb. These metals for forming the metallic layer may be used singly or may be used as a laminate of two or more metals. Alternatively, the metallic layer may be made of an alloy of any of these metals.

The thickness of the metallic layer is preferably 3 nm to 5 μm, more preferably 5 nm to 3 μm, still more preferably 10 nm to 800 nm, yet still more preferably 20 to 500 nm, and particularly preferably 30 to 300 nm. Thus, the above effects can be easily achieved.

Examples of the method for forming the metallic layer include physical vapor deposition, such as evaporation and sputtering, chemical vapor deposition, such as thermal CVD, MOCVD, and plasma CVD, and liquid-phase deposition, such as plating, sol-gel method, and spin coating. Among them, evaporation or sputtering is preferred because the metallic layer can be easily thinned and the above effects due to provision of the metallic layer can be easily achieved.

(Method for Producing Solid Electrolyte Sheet 10)

Hereinafter, a detailed description will be given of a method for producing a solid electrolyte sheet 10.

(i) First Production Method

(a) Making of Green Sheet for First Solid Electrolyte Layer

An organic vehicle containing a binder is added to a solid electrolyte powder to form a slurry. An example that can be used as the binder is polypropylene carbonate. Aside from the binder, a solvent, a plasticizer, and so on may be added to the organic vehicle. The solvent may be either water or an organic solvent, such as ethanol or acetone. However, when water is used as the solvent, an alkaline component, such as sodium, may elute off from the raw material powder to increase the pH of the slurry and thus agglomerate the raw material powder. Therefore, an organic solvent is preferably used.

Instead of the solid electrolyte powder, a raw material powder for the solid electrolyte powder (a powder to become a solid electrolyte through a reaction in a later firing step) may be used. Alternatively, the solid electrolyte powder and the raw material powder for the solid electrolyte powder may be used in mixture.

The average particle diameter (D₅₀) of the solid electrolyte power and the raw material powder for the solid electrolyte powder is preferably 10 μm or less and particularly preferably 5 μm or less. If the average particle diameter of the raw material powder is too large, the area of contact between the raw material powder particles decreases, so that the sintering between the solid electrolyte powder particles and the solid-phase reaction between the raw material powder particles for the solid electrolyte powder are less likely to sufficiently progress. In addition, the solid electrolyte sheet 10 tends to be difficult to thin. The lower limit of the average particle diameter of the solid electrolyte powder and the raw material powder for the solid electrolyte powder is not particularly limited, but it is, actually, preferably not less than 0.05 μm and more preferably not less than 0.1 μm.

The obtained slurry is applied onto a base material made of a PET (polyethylene terephthalate) film or so on, dried, and then peeled off from the base material, thus obtaining a green sheet for a first solid electrolyte layer.

(b) Making of Green Sheet for Second Solid Electrolyte Layer

An organic vehicle containing a binder is added to a mixed powder containing a solid electrolyte powder and/or a raw material powder for the solid electrolyte powder and a polymer powder to make a slurry and the slurry is applied to a base material and dried, thus obtaining a green sheet for a second solid electrolyte layer. The step of making the green sheet for a second solid electrolyte layer is different only in that a polymer powder is added as a solid content, as compared to the step of making the green sheet for a first solid electrolyte layer, and otherwise the same materials and processes can be employed.

The polymer powder is a material for being burned off in the later firing step to form voids 2v in the second solid electrolyte layer 2. Examples of the polymer powder include acrylic resins, polyacrylonitrile, polymethacrylonitrile, and polystyrene.

The average particle diameter (D₅₀) of the polymer powder is preferably 0.1 to 100 μm, more preferably 1 to 80 μm, still more preferably 5 to 70 μm, and particularly preferably 10 to 50 μm. If the average particle diameter of the polymer powder is too small, three-dimensionally connected voids are less likely to be formed in the second solid electrolyte layer 2. On the other hand, if the average particle diameter of the polymer powder is too large, the sintering of the second solid electrolyte layer 2 becomes insufficient, so that the ionic conductivity tends to decrease and, as a result, the rate characteristics tend to decrease.

The content ratio of the solid electrolyte powder and/or the raw material powder for the solid electrolyte powder to the polymer powder is, in terms of volume ratio, preferably 75:25 to 3:97, more preferably 60:40 to 6:94, and still more preferably 40:60 to 9:91. If the content of the polymer powder is too small, three-dimensionally connected voids are less likely to be formed in the second solid electrolyte layer 2. On the other hand, if the content of the polymer powder is too large, the sintering of the second solid electrolyte layer 2 becomes insufficient, so that the ionic conductivity tends to decrease and, as a result, the rate characteristics tend to decrease.

Alternately, the content ratio of the solid electrolyte powder and/or the raw material powder for the solid electrolyte powder to the polymer powder is, in terms of mass ratio, preferably 95:5 to 20:80, more preferably 90:10 to 30:70, and still more preferably 80:20 to 40:60. Reasons why the content ratio is limited as just described is as described above.

The second solid electrolyte layer formed of a plurality of layers having different porosity rates is preferably made by layering two or more types of green sheets made from respective slurries having different content ratios of the solid electrolyte powder and/or the raw material powder for the solid electrolyte powder to the polymer powder.

In the slurry for forming the layer farthest to the first solid electrolyte layer 1, the content ratio of the solid electrolyte powder and/or the raw material powder for the solid electrolyte powder to the polymer powder is, in terms of volume ratio, preferably 75:25 to 3:97, more preferably 60:40 to 6:94, and still more preferably 40:60 to 9:91. Alternately, the above content ratio is, in terms of mass ratio, preferably 95:5 to 20:80, more preferably 90:10 to 30:70, and still more preferably 80:20 to 40:60. If the content of the polymer powder is too small, three-dimensionally connected voids are less likely to be formed. On the other hand, if the content of the polymer powder is too large, the sintering of the second solid electrolyte layer 2 becomes insufficient, so that the ionic conductivity tends to decrease and, as a result, the rate characteristics tend to decrease.

In the slurry for forming the layer closest to the first solid electrolyte layer 1, the content ratio of the solid electrolyte powder and/or the raw material powder for the solid electrolyte powder to the polymer powder is, in terms of volume ratio, preferably 95:5 to 20:80, more preferably 80:20 to 30:70, and still more preferably 70:30 to 40:60. Alternately, the above content ratio is, in terms of mass ratio, preferably 99:1 to 25:75, more preferably 90:10 to 30:70, and still more preferably 80:20 to 35:65. If the content of the polymer powder is too small, three-dimensionally connected voids are less likely to be formed. On the other hand, if the content of the polymer powder is too large, the second solid electrolyte layer 2 is likely to peel off from the first solid electrolyte layer 1 due to contraction during formation of the second solid electrolyte layer 2.

(c) Production of Laminate

The green sheet for a second solid electrolyte layer obtained in the above manner is laid on one or both surfaces of the green sheet for a first solid electrolyte layer obtained in the above manner, thus obtaining a laminate. After the green sheets are layered, they are preferably pressed (more preferably hot-pressed). By doing so, the adhesiveness between the green sheets increases, so that the resultant solid electrolyte sheet 10 can also increase the adhesiveness between the first solid electrolyte layer 1 and the second solid electrolyte layer 2.

The second solid electrolyte layer formed of a plurality of layers having different porosity rates is preferably made by layering green sheets having different content ratios of the solid electrolyte powder and/or the raw material powder for the solid electrolyte powder to the polymer powder to sequentially change the above content rate. Particularly, the layering is preferably performed so that a green sheet having a larger content of the solid electrolyte powder and/or the raw material powder for the solid electrolyte powder is closer to the green sheet for a first solid electrolyte layer.

(d) Firing of Laminate

By firing the laminate obtained in the above manner, the binder in the green sheet for a first solid electrolyte layer is removed to form a first solid electrolyte layer 1, and the binder and the polymer particles in the green sheet for a second solid electrolyte layer are removed to form a second solid electrolyte layer 2. Thus, a solid electrolyte sheet 10 is obtained.

The firing temperature may be appropriately selected according to the type of solid electrolyte used. In the case where the solid electrolyte sheet contains β-alumina or β″-alumina, the firing temperature is preferably 1400° C. or higher, more preferably 1450° C. or higher, and particularly preferably 1500° C. or higher. If the firing temperature is too low, the sintering tends to be insufficient. Alternatively, the reaction of the raw material powder becomes insufficient, so that desired crystals are less likely to be produced. On the other hand, the upper limit of the firing temperature is preferably not higher than 1750° C. and particularly not higher than 1700° C. If the firing temperature is too high, the amount of evaporation of sodium component or the like becomes large, so that other crystals are likely to precipitate and the ionic conductivity of the solid electrolyte sheet 10 is likely to decrease.

In the case where the solid electrolyte contains NASICON crystals, the firing temperature is preferably 1200° C. or higher and particularly preferably 1210° C. or higher. If the firing temperature is too low, the sintering tends to be insufficient. Alternatively, the reaction of the raw material powder becomes insufficient, so that desired crystals are less likely to be formed. On the other hand, the upper limit of the firing temperature is preferably not higher than 1400° C. and particularly not higher than 1300° C. If the firing temperature is too high, the amount of evaporation of sodium component or the like becomes large, so that other crystals are likely to precipitate and the ionic conductivity of the solid electrolyte sheet 10 is likely to decrease.

The firing time is appropriately adjusted so that sintering sufficiently progress. Specifically, the firing time is preferably 10 to 120 minutes and particularly preferably 20 to 80 minutes.

(ii) Second Production Method

(a) Preparation of First Solid Electrolyte Layer 1

For example, a commercially available solid electrolyte sheet can be used as the first solid electrolyte layer 1. If necessary, the solid electrolyte sheet may be adjusted in thickness by polishing to have a desired thickness.

Alternatively, the first solid electrolyte layer 1 may be made by firing a green sheet for a first solid electrolyte layer made in accordance with the process (a) in the first production method.

(b) Preparation of Slurry

A slurry for a second solid electrolyte layer is prepared in the same manner as the process (b) in the first production method.

(c) Production of Laminate

The slurry is applied to one or both surfaces of the first solid electrolyte layer 1, thus obtaining a laminate in which a slurry layer is formed on the one or both surfaces of the first solid electrolyte layer 1.

(d) Firing of Laminate

By firing the laminate obtained in the above manner, the binder and the polymer particles in the slurry layer are removed to form a second solid electrolyte layer 2. Thus, a solid electrolyte sheet 10 is obtained. In terms of the firing time and firing temperature, the same conditions as in the first production method can be adopted.

It is also possible that in the step (c) a green sheet for a second solid electrolyte layer, instead of the slurry layer, is laid on the surface of the first solid electrolyte layer 1 to obtain a laminate and the laminate is then fired to obtain a solid electrolyte sheet 10.

Also in the second production method, like the first production method, two or more types of slurries (or green sheets) having different content ratios of the solid electrolyte powder and/or the raw material powder for the solid electrolyte powder to the polymer powder may be formed, layered by repeating the application of them to the surface of the first solid electrolyte layer 1 and drying of them, and then fired, thus forming a second solid electrolyte layer formed of a plurality of layers having different porosity rates.

### EXAMPLES

Hereinafter, the present invention will be described in detail with reference to examples, but the present invention is not limited to the following examples.

Tables 1 and 2 show Examples 1 to 9 and Comparative Examples 1 and 2.

TABLE 1

| | | | Ex. 1 | Ex. 2 | Ex. 3 | Ex. 4 | Ex. 5 |
|---|---|---|---|---|---|---|---|
| Solid | First solid | Solid electrolyte | β″- | β″- | β″- | NASICON | β″- |
| Electrolyte | electrolyte | | alumina | alumina | alumina | | alumina |
| Sheet | layer | Thickness [μm] | 89 | 71 | 78 | 67 | 89 |
| | | Voidage (%) | 0 | 0.9 | 2.4 | 1.9 | 0 |
| | Second solid | Solid electrolyte | β″- | β″- | β″- | NASICON | β″- |
| | electrolyte | | alumina | alumina | alumina | | alumina |
| | layer | Material for | acrylic | acrylic | acrylic | acrylic | acrylic |
| | | polymer powder | | | | | |
| | | Average particle diameter | 20 | 20 | 20 | 20 | 20 |
| | | of polymer power [μm] | | | | | |
| | | Thickness [μm] | 32 | 39 | 35 | 38 | 31 |
| | | Voidage (%) | 87.5 | 90.3 | 79.2 | 78.2 | 87.5 |
| | | Porosity rate [%] | 61.8 | 78.2 | 50.3 | 40.8 | 61.8 |
| | | Surface roughness Ra [μm] | 8.4 | 5.8 | 8.2 | 6.9 | 8.4 |
| | | Solid electrolyte powder | 25:75 | 13:87 | 25:75 | 52:47 | 25:75 |
| | | to Polymer particles | | | | | |
| | | [volume ratio] | | | | | |
| | Profile line length/ | | 3.8 | 2.2 | 3.5 | 2.8 | 3.8 |
| | Reference line length | | | | | | |
| | Resistance R₁ of First | | 149.4 | 119.1 | 130.9 | 112.4 | 149.4 |
| | solid electrolyte | | | | | | |
| | layer [Ω] | | | | | | |
| | Resistance R₂ of Solid | | 10.0 | 29.1 | 10.9 | 13.5 | 9.8 |
| | electrolyte | | | | | | |
| | sheet [Ω] | | | | | | |
| | Surface area A₂ of | | 14.9 | 4.1 | 12 | 8.3 | 15.3 |
| | second solid | | | | | | |
| | electrolyte layer per | | | | | | |
| | unit area [cm²] | | | | | | |
| Positive | Active material | | Na₂FeP₂O₇ | Na₂FeP₂O₇ | Na₂FeP₂O₇ | Na₂FeP₂O₇ | Na₂FeP₂O₇ |
| Electrode | Solid electrolyte powder | | β″- | β″- | β″- | NASICON | β″- |
| Layer | | | alumina | alumina | alumina | | alumina |
| | Thickness [μm] | | 31 | 30 | 98 | 29 | 30 |
| Metallic | Material | | — | — | — | — | Au |
| Layer | Thickness [nm] | | — | — | — | — | 90 |
| Discharge | 0.1 C | | 82 | 80 | 62 | 79 | 83 |
| Capacity | 0.5 C | | 62 | 60 | 40 | 55 | 61 |
| | 5 C | | 0 | 0 | 0 | 0 | 25 |
| | 10 C | | 0 | 0 | 0 | 0 | 0 |
| Discharge Capacity | | | 51 | — | — | — | 90 |
| Retention [%] | | | | | | | |
| | | | | | | Comp. | Comp. |
| | | | Ex. 6 | Ex. 7 | Ex. 8 | Ex. 1 | Ex. 2 |
| Solid | First solid | Solid electrolyte | β″- | β″- | β″- | β″- | β″- |
| Electrolyte | electrolyte | | alumina | alumina | alumina | alumina | alumina |
| Sheet | layer | Thickness [μm] | 74 | 76 | 89 | 70 | 82 |
| | | Voidage (%) | 1.1 | 1.2 | 0 | 0.9 | 1.2 |
| | Second solid | Solid electrolyte | β″- | β″- | β″- | β″- | β″- |
| | electrolyte | | alumina | alumina | alumina | alumina | alumina |
| | layer | Material for | cross- | cross- | acrylic | acrylic | acrylic |
| | | polymer powder | linked | linked | | | |
| | | | polymeth- | polymeth- | | | |
| | | | acrylate | acrylate | | | |
| | | Average particle diameter | 20 | 8 | 20 | 20 | 20 |
| | | of polymer power [μm] | | | | | |
| | | Thickness [μm] | 34 | 29 | 118 | 27 | 28 |
| | | Voidage (%) | 80.2 | 54.2 | 62.4 | 0.9 | 1.2 |
| | | Porosity rate [%] | 54.1 | 31.4 | 38.9 | 2.4 | 4.5 |
| | | Surface roughness Ra [μm] | 7.2 | 2.4 | 7.1 | 0.7 | 0.8 |
| | | Solid electrolyte powder | 25:75 | 25:75 | 25:75 | 100:0 | 100:0 |
| | | to Polymer particles | | | | | |
| | | [volume ratio] | | | | | |

| | | | | | | |
|---|---|---|---|---|---|---|
| | Profile line length/ | 2.4 | 1.5 | 3.1 | 1.1 | 1.1 |
| | Reference line length | | | | | |
| | Resistance R₁ of First | 124.2 | 127.5 | 149.4 | 117.5 | 137.6 |
| | solid electrolyte | | | | | |
| | layer [Ω] | | | | | |
| | Resistance R₂ of Solid | 12.8 | 51.0 | 8.2 | 117.5 | 125.1 |
| | electrolyte | | | | | |
| | sheet [Ω] | | | | | |
| | Surface area A₂ of | 9.7 | 2.5 | 18.2 | 1 | 1.1 |
| | second solid | | | | | |
| | electrolyte layer per | | | | | |
| | unit area [cm²] | | | | | |
| Positive | Active material | Na₂FeP₂O₇ | Na₂FeP₂O₇ | Na₂FeP₂O₇ | Na₂FeP₂O₇ | Na2FeP2O7 |
| Electrode | Solid electrolyte powder | β″- | β″- | β″-alumina | β″-alumina | β″-alumina |
| Layer | | alumina | alumina | | | |
| | Thickness [μm] | 31 | 34 | 34 | 34 | 93 |
| Metallic | Material | — | — | — | — | — |
| Layer | Thickness [nm] | — | — | — | — | — |
| Discharge | 0.1 C | 80 | 77 | 83 | 74 | — |
| Capacity | 0.5 C | 61 | 32 | 61 | 14 | — |
| | 5 C | 0 | 0 | 20 | 0 | — |
| | 10 C | 0 | 0 | 13 | 0 | — |

| | | | | | |
|---|---|---|---|---|---|
| Discharge Capacity | — | — | — | — | — |
| Retention [%] | | | | | |

TABLE 2

| | | | | Example 9 |
|---|---|---|---|---|
| Solid | First solid electrolyte layer | | Solid electrolyte | β″-alumina |
| Electrolyte | | | Thickness [μm] | 89 |
| Sheet | | | Voidage [%] | 0 |
| | Second solid electrolyte layer | Whole | Voidage [%] | 83.6 |
| | | | Porosity rate [%] | 58.4 |
| | | | Surface roughness Ra [μm] | 8.3 |
| | | First layer | Solid electrolyte | β″-alumina |
| | | | Material for polymer powder | acrylic |
| | | | Average particle diameter of polymer powder [μm] | 20 |
| | | | Thickness [μm] | 20 |
| | | | Porosity rate | 19.8 |
| | | | Solid electrolyte powder to Polymer particles [volume ratio] | 58:42 |
| | | Second layer | Solid electrolyte | β″-alumina |
| | | | Material for polymer powder | acrylic |
| | | | Average particle diameter of polymer powder [μm] | 20 |
| | | | Thickness [μm] | 177 |
| | | | Porosity rate [%] | 62.4 |
| | | | Solid electrolyte powder to Polymer particles [volume ratio] | 25:75 |

| | | |
|---|---|---|
| | Profile line length/Reference line length | 2.1 |
| | Resistance R₁ of First solid electrolyte layer [Ω] | 149.4 |
| | Resistance R₂ of Solid electrolyte sheet [Ω] | 5.6 |
| | Surface area A₂ of second solid electrolyte layer per unit area [cm²] | 26.7 |
| Positive | Active material | Na₂FeP₂O₇ |
| Electrode | Solid electrolyte powder | β″-alumina |
| Layer | Thickness [μm] | 34 |
| Metallic Layer | Material | — |
| | Thickness [nm] | — |
| Discharge | 0.1 C | 82 |
| Capacity | 0.5 C | 65 |
| | 5 C | 31 |
| | 10 C | 20 |

| | |
|---|---|
| Discharge Capacity Retention [%] | — |

(a) Making of Solid Electrolyte Sheet

(a-1) Making of Green Sheet for First Solid Electrolyte Layer

An amount of 20 parts by mass of polypropylene carbonate (QPAC 40 by Empower Materials) was added as a binder to 100 parts by mass of solid electrolyte powder (average particle diameter: 2.5 μm) described in Tables 1 and 2 and the obtained mixture was dispersed into N-methylpyrrolidone, followed by well stirring with a planetary centrifugal mixer to forma slurry. The obtained slurry was applied onto a PET film using a doctor blade, dried at 70° C., and then peeled off from the PET film, thus obtaining a green sheet for a first solid electrolyte. The composition of NASICON crystals used was Na_{3.05}Zr₂Si_{2.06}P_{0.95}O₁₂.

(a-2) Making of Green Sheet for Second Solid Electrolyte Layer

Solid electrolyte powder and polymer particles were weighed to reach each of the volume ratios shown in Tables 1 and 2. The polymer particles used were acrylic polymer particles with an average particle diameter of 20 μm (ADVANCELL HB-2051 manufactured by SEKISUI CHEMICAL CO., LTD.), cross-linked polymethylmethacrylate particles with an average particle diameter of 20 μm (MBX-20 manufactured by Sekisui Kasei Co., Ltd.) or cross-linked polymethylmethacrylate particles with an average particle diameter of 8 μm (MBX-8 manufactured by Sekisui Kasei Co., Ltd.). An amount of 20 parts by mass of polypropylene carbonate was added as a binder to 100 parts by mass of the mixture of the above solid electrolyte powder and polymer particles, and the obtained mixture was dispersed into N-methylpyrrolidone, followed by well stirring with a planetary centrifugal mixer to form a slurry. The obtained slurry was applied onto a PET film using a doctor blade, dried at 70° C., and then peeled off from the PET film, thus obtaining a green sheet for a second solid electrolyte. In Example 9, two types of green sheets (“First layer” and “Second layer” in Table 2) having different content ratios between solid electrolyte powder and polymer particles were made.

(a-3) Firing of Green Sheets

Green sheets for second solid electrolyte layers were laid on both surfaces of the green sheet for a first solid electrolyte layer obtained as above and the layered green sheets were hot-pressed and then fired at 1600° C. in Examples 1 to 3, Examples 5 to 9, and Comparative Examples 1 and 2 or 1220° C. in Example 4, thus making a solid electrolyte sheet in which porous second solid electrolyte layers were formed on both surfaces of a dense first solid electrolyte layer. In Example 9, laminates were each obtained by layering the green sheets for a second solid electrolyte layer as “First layer” and “Second layer” described in Table 2 and hot-pressing them, and the laminates were laid on both surfaces of the green sheet for a first solid electrolyte layer, followed by hot-pressing and then firing at 1600° C. In doing so, the layering of the laminates on the green sheet for a first solid electrolyte layer was performed so that the green sheets for a second solid electrolyte layer as “First layers” were located closer to the green sheet for a first solid electrolyte layer.

FIG. 1 shows a cross-sectional image of the interface between the first solid electrolyte layer and the second solid electrolyte layer and around the interface in the solid electrolyte sheet of Example 1. FIG. 1(a) is a view showing a reference line which is a straight line drawn along the surface of the first solid electrolyte layer and FIG. 1(b) is a view showing a profile line which is a curved line drawn along the surface of the second solid electrolyte layer. Results of the ratios of the length of the profile line to the length of the reference line ((profile line length)/(reference line length)) obtained by image analysis are shown in Tables 1 and 2. Image analysis software “Image J” was used for the image analysis.

(a-4) Measurement of Resistance of Solid Electrolyte Sheet and Calculation of Surface Area Thereof

The green sheet for a first solid electrolyte layer was fired at 1600° C. in Examples 1 to 3, Examples 5 to 9, and Comparative Examples 1 and 2 or 1220° C. in Example 4, thus making a first solid electrolyte layer.

A gold electrode was formed as an ion blocking electrode in a range of 4 mm in diameter on a surface of the obtained first solid electrolyte layer by RF sputtering and the first solid electrolyte layer was then measured in a frequency range of 1 to 107 Hz with an applied voltage of 5 mV by the AC impedance method to determine the resistance R₁ of the first solid electrolyte layer from a Cole-Cole plot. The measurement was performed in an atmosphere with a dew point of −40° C. or lower and a temperature of 0° C.

A solid electrolyte sheet which was made in (a-3) and in which second solid electrolyte layers were formed on both surfaces of a first solid electrolyte layer (hereinafter, referred to simply as a solid electrolyte sheet) was determined in terms of resistance R₂ in the same manner as above.

Using the resistances R₁ and R₂ obtained as above, the surface area of the second solid electrolyte layer per unit area (specifically, the surface area of the second solid electrolyte layer within a 1-cm square area in plan view) was determined in the following manner.

First, the ionic conductivity σ1 of the first solid electrolyte layer was determined from the formula (1) below. In the formula, A₁ represents the surface area of the first solid electrolyte layer per unit area, but, because of the first solid electrolyte layer being dense and having a flat surface, A₁ can be considered to be 1 cm². Furthermore, t₁ represents the thickness of the first solid electrolyte layer.

$$[ Math . 1 ]$$

$$Ionic conductivity {σ}_{1} [ S / cm ] = \frac{1}{Resistance {R}_{1} [ Ω ] \times \frac{Surface area {A}_{1} [ {cm}^{2} ]}{Thickness {t}_{1} [ cm ]}} \qquad ( 1 )$$

The ionic conductivity of the first solid electrolyte layer and the ionic conductivity per unit area of the solid electrolyte sheet are equal to each other because their constituent material is the same. Therefore, the surface area A₂ of the solid electrolyte sheet per unit area can be determined from the formula (2) below. In the formula, t₂ represents the thickness of the solid electrolyte sheet. Since the second solid electrolyte layers are formed on the surfaces of the solid electrolyte sheet, the surface area A₂ calculated below can be considered as the surface area of the second solid electrolyte layer.

$$[ Math . 2 ]$$

$$Surface area {A}_{2} [ {cm}^{2} ] = \frac{Thickness {t}_{2} [ cm ]}{Ionic conductivity {σ}_{1} [ S / cm ] \times Resistance {R}_{2} [ Ω ]} \qquad ( 2 )$$

(b) Making of Positive Electrode Layer

(b-1) Preparation of Positive-Electrode Active Material Precursor Powder

Using sodium metaphosphate (NaPO₃), ferric oxide (Fe₂O₃), and orthophosphoric acid (H₃PO₄) as raw materials, a raw material powder was formulated to have a composition of, in % by mole, 40% Na₂O, 20% Fe₂O₃, and 40% P₂O₅. The raw material powder was melted in an air atmosphere at 1250° C. for 45 minutes. Thereafter, the molten glass was poured between a pair of rollers and formed into a film with rapid cooling, thus preparing a positive-electrode active material precursor.

The obtained positive-electrode active material precursor was ground for five hours in a ball mill using 20-mm diameter Al₂O₃ balls, subsequently ground for 100 hours in a ball mill in ethanol using 5-mm diameter ZrO₂ balls, and then ground for five hours at 300 rpm (with a 10-minute pause every 10 minutes) in a planetary ball mill P6 μmanufactured by Fritsch GmbH and loaded with 0.3-mm diameter ZrO₂ balls to obtain a positive-electrode active material precursor powder having an average particle diameter D₅₀ of 0.2 μm.

(b-2) Making of Positive Electrode Composite Material

The above positive-electrode active material precursor powder, the solid electrolyte powder described in Tables 1 and 2, and acetylene black (SUPER C65 manufactured by TIMCAL) as a conductive agent were weighed to reach a mass ratio of 83:13:4 and these powders were mixed for approximately 30 minutes with an agate pestle in an agate mortar, thus obtaining a positive electrode composite material. An amount of 20 parts by mass of N-methylpyrrolidinone containing 10% by mass polypropylene carbonate was added to 100 parts by mass of the obtained positive electrode composite material and the mixture was stirred well with a planetary centrifugal mixer to form a slurry.

(c) Production of Test Cell

The above positive electrode composite material formed into a slurry was applied to one surface of the obtained solid electrolyte sheet over an area of 1 cm² and then dried at 70° C. for three hours. Next, the positive electrode composite material was fired at 525° C. for 30 minutes in a mixed gas atmosphere of nitrogen and hydrogen (96% by volume nitrogen and 4% by volume hydrogen) to sinter the positive electrode composite material and crystallize the positive-electrode active material precursor powder, thus forming a positive electrode layer having a thickness described in Tables 1 and 2. When the X-ray diffraction pattern of the obtained positive electrode layer was checked, diffraction lines originating from Na₂FeP₂O₇, which is an active material crystal, were confirmed.

FIG. 2 shows a cross-sectional image of the interface between the first solid electrolyte layer and the second solid electrolyte layer and around the interface in the solid electrolyte sheet of Example 1. FIG. 2(a) is a view showing a reference line which is a straight line drawn along the surface of the first solid electrolyte layer, and FIG. 2(b) is a view showing a profile line which is a curved line drawn along the surface of the second solid electrolyte layer.

Next, a 300-nm thick gold electrode as a current collector was formed on the surface of the positive electrode layer using a sputtering device (SC-701AT manufactured by Sanyu Electron Co., Ltd.). Thereafter, metallic sodium serving as a counter electrode was pressure-bonded to the other surface of the solid electrolyte sheet opposite to the surface thereof on which the positive electrode layer was formed and the obtained product was placed on a lower lid of a coin cell and covered with an upper lid to produce a CR2032-type test cell. In Example 5, a 90-nm thick gold electrode was formed on the other surface of the solid electrolyte sheet opposite to the surface thereof on which the positive electrode layer was formed, using a sputtering device (SC-701AT manufactured by Sanyu Electron Co., Ltd.) and metallic sodium was pressure-bonded to the surface of the gold electrode.

(d) Charge and Discharge Test

A charge and discharge test was performed using each of the obtained test cells. The results are shown in Tables 1 and 2. In the charge and discharge test, charging (release of sodium ions from the positive-electrode active material) was implemented by CC (constant-current) charging from the open circuit voltage (OCV) to 4.5 V and discharging (absorption of sodium ions to the positive-electrode active material) was implemented by CC discharging from 4.5 V to 2 V. The C rate was 0.1 C, 0.5 C or 5 C and the test was performed at 30° C. The discharge capacity is defined as an amount of electricity discharged per unit weight of the positive-electrode active material contained in the positive electrode layer. Furthermore, a cycle test was performed at 0.5 C. Specifically, the discharge capacity retention ((discharge capacity after 300 cycles)/(discharge capacity after one cycle)×100(%)) was determined from the discharge capacity after one cycle at 0.5 C and the discharge capacity after 300 cycles at 0.5 C.

As shown in Tables 1 and 2, in Examples 1 to 9, three-dimensionally connected voids were sufficiently formed in the inside of the second solid electrolyte layer and the resistance of the solid electrolyte sheet was as small as 5.6 to 51.0Ω. In addition, the ratio between the profile line length and the reference line length was as large as 1.5 to 3.8, so that the area of contact between the solid electrolyte sheet and the positive electrode layer was large and good discharge capacities of 62 to 83 mAh/g at 0.1 C and 32 to 65 mAh/g at 0.5 C were exhibited. Since in Example 5 a metallic layer was provided between the solid electrolyte layer and metallic sodium, the rate characteristics increased, a discharge capacity of 25 mAh/g at 5 C was exhibited, and the discharge capacity retention was as good as 90%. In Example 8, the thickness of the second solid electrolyte layer was as thick as 118 μm and the area of contact between the electrode layer and the solid electrolyte layer increased. Therefore, the rate characteristic increased and a discharge capacity of 13 mAh/g at 10 C was exhibited. In Example 9, the whole thickness of the second solid electrolyte layer was as thick as 197 μm, so that a discharge capacity of 31 mAh/g at 5 C and a discharge capacity of 20 mAh/g at 10 C were exhibited. Since in Example 9 the second solid electrolyte layer was formed of two layers having different porosity rates, despite the second solid electrolyte layer having a very large thickness of 197 μm, no peel-off occurred at the interface with the first solid electrolyte layer.

Unlike the above, in Comparative Examples 1 and 2, only closed voids were present in the inside of the second solid electrolyte layer and three-dimensionally connected voids were not formed. Therefore, the resistance of the solid electrolyte sheet was as large as 117.5 to 125.1Ω. In addition, the ratio between the profile line length and the reference line length was as small as 1.1, so that the area of contact between the solid electrolyte sheet and the positive electrode layer was small. In Comparative Example 1, a relatively good discharge capacity of 74 mAh/g was exhibited at 0.1 C, but the discharge capacity at 0.5 C was as low as 14 mAh/g. In Comparative Example 2, because the thickness of the positive electrode layer was as large as 93 μm, the positive electrode peeled off from the second solid electrolyte layer during firing, so that charge and discharge were unsuccessful.

### REFERENCE SIGNS LIST

1 first solid electrolyte layer
1a, 1b principal surface
2 second solid electrolyte layer
2a, 2b principal surface
2s solid electrolyte
2v void
10 solid electrolyte sheet

1: A solid electrolyte sheet in which a second solid electrolyte layer is formed on at least one of both surfaces of a first solid electrolyte layer, the second solid electrolyte layer being a porous solid electrolyte layer.

2: The solid electrolyte sheet according to claim 1, wherein the second solid electrolyte layer is a porous solid electrolyte layer having three-dimensionally connected voids.

3: The solid electrolyte sheet according to claim 1, wherein assuming that in a cross-sectional image of an interface between the first solid electrolyte layer and the second solid electrolyte layer and around the interface, a straight line drawn along a surface of the first solid electrolyte layer is a reference line and a curved line drawn along a surface of the second solid electrolyte layer is a profile line, a ratio of a length of the profile line to a length of the reference line ((profile line length)/(reference line length)) is 1.3 to 50.

4: The solid electrolyte sheet according to claim 1, wherein the second solid electrolyte layer is composed of a plurality of layers having different porosity rates.

5: The solid electrolyte sheet according to claim 4, wherein in the plurality of layers having different porosity rates, the layer closer to the first solid electrolyte layer has a lower porosity rate.

6: The solid electrolyte sheet according to claim 1, wherein a surface area of the second solid electrolyte layer per cm² in plan view is 3 cm² or more.

7: The solid electrolyte sheet according to claim 1, wherein the second solid electrolyte layer has an arithmetic mean roughness Ra of 2.5 μm or more.

8: The solid electrolyte sheet according to claim 1, wherein the second solid electrolyte layer is formed on each of both surfaces of the first solid electrolyte layer.

9: The solid electrolyte sheet according to claim 1, having a thickness of 2400 μm or less.

10: The solid electrolyte sheet according to claim 1, wherein the first solid electrolyte layer and/or the second solid electrolyte layer contain at least one material selected from β″-alumina, β-alumina, and NASICON crystals.

11: The solid electrolyte sheet according to claim 1, being for use in an all-solid-state sodium ion secondary battery.

12: An all-solid-state secondary battery comprising: the solid electrolyte sheet according claim 1; and an electrode layer formed on a surface of the second solid electrolyte layer of the solid electrolyte sheet.

13: The all-solid-state secondary battery according to claim 12, wherein the voids in the second solid electrolyte layer are penetrated by a material forming the electrode layer.

14: A method for producing the solid electrolyte sheet according to claim 1, the method comprising the steps of:
(a) adding an organic vehicle containing a binder to a solid electrolyte powder and/or a raw material powder for the solid electrolyte powder to make a slurry, applying the slurry to a base material, and then drying the slurry to obtain a green sheet for a first solid electrolyte layer;
(b) adding an organic vehicle containing a binder to a mixed powder containing a solid electrolyte powder and/or a raw material powder for the solid electrolyte powder and a polymer powder to make a slurry, applying the slurry to a base material, and then drying the slurry to obtain a green sheet for a second solid electrolyte layer;
(c) laying the green sheet for a second solid electrolyte layer on at least one of both surfaces of the green sheet for a first solid electrolyte layer to obtain a laminate; and
(d) firing the laminate to remove the binder in the green sheet for a first solid electrolyte layer and thus form a first solid electrolyte layer and concurrently remove the binder and polymer particles in the green sheet for a second solid electrolyte layer and thus form a second solid electrolyte layer.

15: A method for producing the solid electrolyte sheet according to claim 1, the method comprising the steps of:
(a) preparing a first solid electrolyte layer;
(b) adding an organic vehicle containing a binder to a mixed powder containing a solid electrolyte powder and/or a raw material powder for the solid electrolyte powder and a polymer powder to make a slurry;
(c) applying the slurry to at least one of both surfaces of the first solid electrolyte layer to obtain a laminate in which a slurry layer is formed on the surface of the first solid electrolyte layer; and
(d) firing the laminate to remove the binder and polymer particles in the slurry layer and thus form a second solid electrolyte layer.

16: The method for producing the solid electrolyte sheet according to claim 14, wherein the polymer powder has an average particle diameter of 0.1 to 100 μm.

17: The method for producing the solid electrolyte sheet according to claim 14, wherein a content ratio of the solid electrolyte powder and/or the raw material powder for the solid electrolyte powder to the polymer powder is 75:25 to 3:97 in terms of volume ratio.
